(19) United States
(12) Patent Application Publication
(10) Pub. No.: US 2011/0102637 A1
(43) Pub. Date: May 5, 2011

(54) TRAVEL VIDEOS

(75) Inventor: Kristian Lasseson, Kavlinge (SE)

(73) Assignee: SONY ERICSSON MOBILE COMMUNICATIONS AB, Lund (SE)

(21) Appl. No.: 12/611,246

(22) Filed: Nov. 3, 2009

(51) Int. Cl. H04N 5/262; H04M 1/00

(52) U.S. Cl. 348/239; 455/556.1; 348/E05.051

(57) ABSTRACT

A device may include a processor. The processor may associate a trip with a video clip, modify a rate at which images for frames of the video clip are captured, create the frames of the video clip based on the images, tag each of the frames with location information, the location information designating a point on a path of the trip, and store the video clip.

### BACKGROUND

Some of today's mobile devices are equipped with global positioning system (GPS) hardware/software components or inertial components. These components enable the mobile devices to operate as navigational devices.

### SUMMARY

According to one aspect, a device may include a processor. The processor may be configured to associate a trip with a first video clip, modify a rate at which images for frames of the first video clip are captured, create the frames of the first video clip based on the images, tag each of the frames with location information, the location information designating a point on a path of the trip, and store the first video clip.

Additionally, the processor may be configured to: modify the rate based on at least one of road conditions or weather conditions.

Additionally, the processor may be configured to: modify the rate based on speed at which the device is moving.

Additionally, the processor may be configured to: modify the rate based on at least one of time of day or month of year.

Additionally, the device may include a mobile phone.

Additionally, the device may further include a rear camera for capturing the images.

Additionally, the device may further include a network interface to transmit the first video clip to a remote device at which the first video clip is to be stored.

Additionally, the location information may include at least one of information identifying a geographical location of the device, information identifying a time at which an image corresponding to the frame is captured, or coordinates on a map associated with the trip.

Additionally, the device may further include navigational components, wherein the processor is further configured to obtain, from the navigational components, the information identifying the geographical location.

Additionally, the device may further include a display, wherein the processor is further configured to receive information to identify and retrieve a second video clip from a remote device, and display the second video clip on the display.

Additionally, the information to identify the second video clip may include information for identifying the trip.

Additionally, the device may further include a display to show an interactive map, and to play a portion of a video clip based on user input received via the interactive map.

Additionally, the processor may be further configured to receive user input identifying at least one of a location on a route of a trip associated with the second video clip, a time during a trip associated with the second video clip, or a position on a map that includes a route of a trip associated with the second video clip. Further, the processor may play a portion of the second video clip, the portion corresponding to the user input.

Additionally, the processor may be further configured to associate a start location and an end location of the trip with the first video clip.

According to another aspect, a method may include receiving a request for a travel video from a user device, the travel video associated with a trip, identifying a route of the trip, retrieving video clips that correspond to the route, assembling the travel video by combining the video clips, and sending the travel video to the user device.

Additionally, identifying the route of the trip may include obtaining from the request, information identifying a start location and an end location of the trip, retrieving a list of routes based on the information, and selecting the route from the list of routes.

Additionally, assembling the travel video may include interleaving at least two of the video clips, or concatenating the video clips.

Additionally, retrieving the video clips may include retrieving the video clips from a plurality of user devices.

According to yet another aspect, a method may include associating a travel video with information that identifies a trip, modifying a rate at which images of the travel video are captured, creating frames of the travel video from the images, tagging each of the frames with location information, the location information designating a point on a path of the trip, and storing the travel video.

Additionally, the method may further include displaying an interactive map, and displaying a video clip based on user input received via the interactive map.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIGS. 1A through 1C illustrate concepts described herein;

FIG. 2 is a diagram of an exemplary network in which the concepts described herein may be implemented;

FIGS. 3A and 3B are front and rear views of an exemplary user device of FIG. 2;

FIG. 4 is a block diagram of exemplary components of network device of FIG. 2;

FIG. 5 is a block diagram of exemplary functional components of the user device of FIG. 2;

FIG. 6 is a diagram of an exemplary graphical user interface (GUI) of the exemplary video play logic of FIG. 5;

FIG. 7 is a block diagram of exemplary functional components of a server device of FIG. 2;

FIG. 8 is a flow diagram of an exemplary process associated with the user device of FIG. 2;

FIG. 9 is a flow diagram of an exemplary process associated with the server device of FIG. 2; and

FIGS. 10A and 10B illustrate an example associated with the processes of FIGS. 8 and 9.

### DETAILED DESCRIPTION

The following detailed description refers to the accompanying drawings. The same reference numbers in different drawings may identify the same or similar elements. As used herein, the term “video” may not refer to only visual information, but may refer to visual and/or audio information. In addition, the term “travel video” may refer to a video that is associated with a trip having a starting location and an end location.

In the following, a system may enable a user to easily and conveniently record and/or access travel videos. To view a travel video, a user may designate, via a user interface installed on a user device (e.g. an interactive map), locations or times in a trip. The travel video may provide detailed view of roads and surroundings, and may allow a user to better plan a trip in advance and/or retain an improved record of the trip.

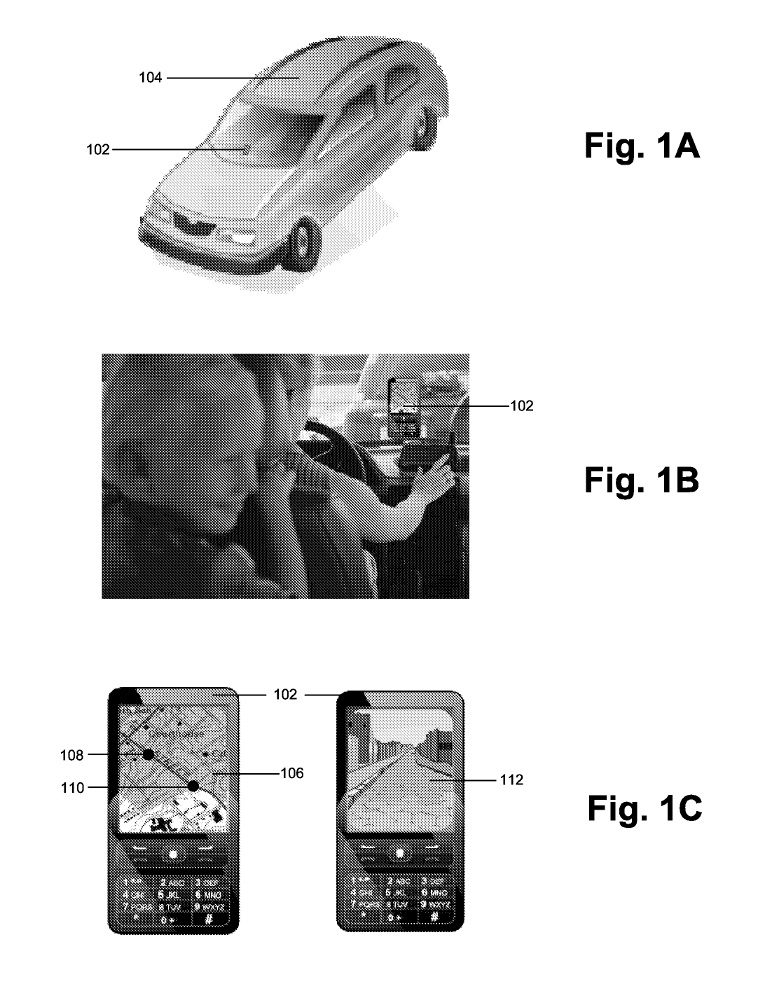

FIGS. 1A through 1C illustrate an example of the above concepts. Assume that a user is on a trip. FIG. 1A shows an exemplary user device 102 positioned near or affixed to a windshield of an exemplary vehicle 104, via a device holder (not shown).

FIG. 1B shows user device 102 of FIG. 1A from the interior of vehicle 104. As shown, the display of user device 102 may face the user when the user is driving vehicle 104. During the trip, while the user is viewing or using an application (e.g., a navigation program) installed on user device 102, user device 102 may run a background process to capture an image and/or a video of scenes in front of vehicle 104 via a rear camera (not shown) on the backside of user device 102.

After the trip, the user may view any portion of the travel video via an application installed on user device 102. FIG. 1C illustrates one example of the process. To view any portion the trip, the user may designate, via the application, a starting point 108 and an endpoint 110 of the portion of the trip on an interactive map 106 shown on user device 102. Subsequently, the application may display a view 112 of the corresponding travel video.

As described below, these and related concepts may be implemented in different embodiments and configurations.

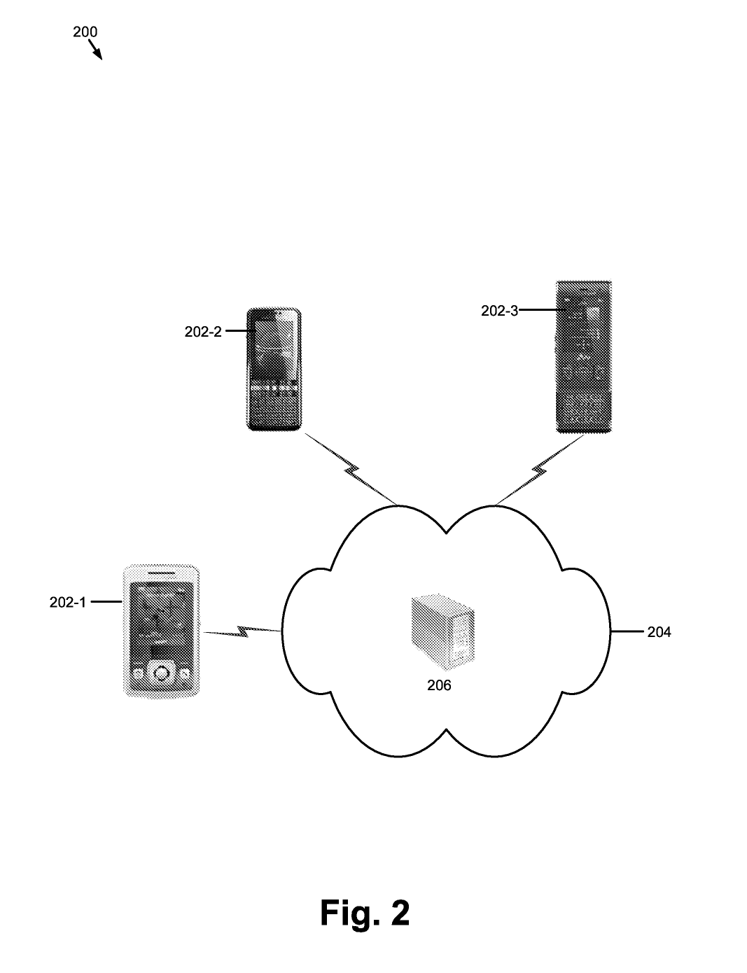

FIG. 2 is a diagram of an exemplary network 200 in which the concepts described herein may be implemented. As shown, network 200 may include user devices 202-1 through 202-3 (collectively referred to as “user devices 202” and individually as “user device 202-x”), network 204, and a server device 206. Depending on the implementation, network 200 may include additional, fewer, or different devices than the ones illustrated in FIG. 2. For example, in some implementations, network 200 may include hundreds, thousands, or more of user devices and/or additional server devices.

User device 202-x may record/create travel videos for trips. Although the example illustrated in FIG. 1A through 1C involves an automobile trip, the trips may include other types of traveling/vehicles, such as airplane rides, boat rides, bicycle rides, walks, hikes, etc. In addition, the trips may take place on other types of paths, such as canals, railways, or other track-bound path (e.g., cycle tracks, pathways, etc.). Further, the travel video may not only include road scenes, but other types of scenes, such as scenes inside a car during a trip, etc. Once the travel videos are recorded, user device 202-x may play the recorded travel videos. In some implementations, user device 202-x may upload the travel videos to another device, such as server device 206.

Network 204 may include a cellular network, a public switched telephone network (PSTN), a local area network (LAN), a wide area network (WAN), a wireless LAN, a metropolitan area network (MAN), a Long Term Evolution (LTE) network, an intranet, the Internet, a satellite-based network, a fiber-optic network (e.g., passive optical networks (PONs)), an ad hoc network, any other network, or a combination of networks. Devices that are shown in FIG. 2 may connect to network 204 via wireless, wired, or optical communication links. In addition, network 204 may allow any of devices 202 and 206 to communicate with any other device 202-x.

Server device 206-x may receive one or more travel videos and maintain the travel videos in a database. In addition, when user device 202-x requests a travel video, server device 206-x may retrieve video clips associated with the trip and send them to user device 202-x over network 204.

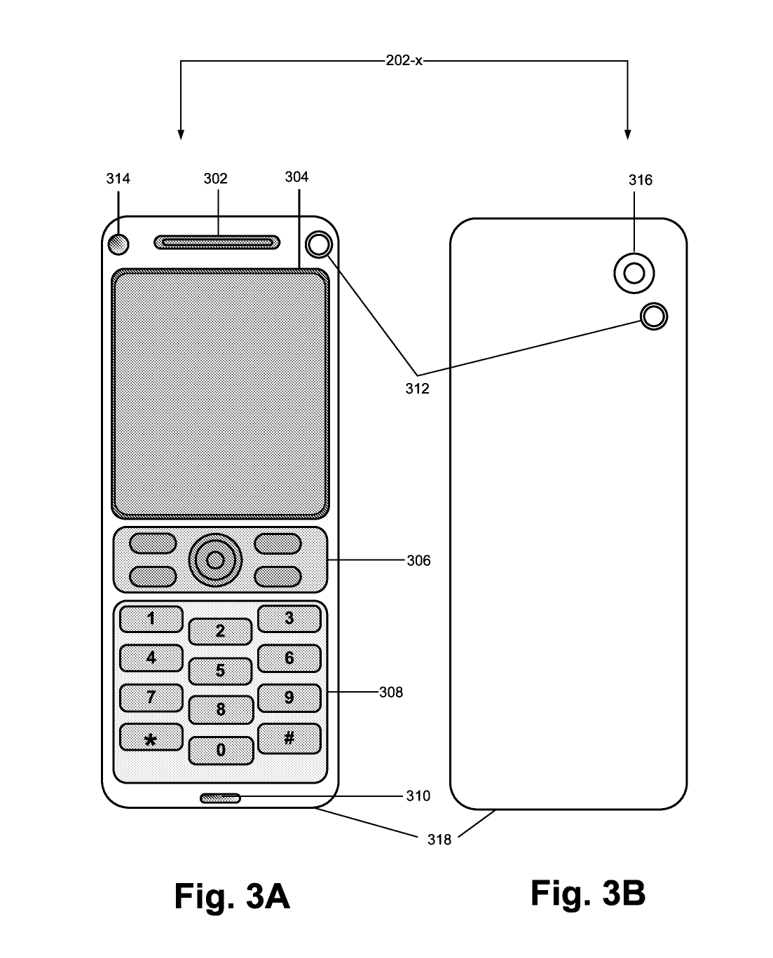

FIGS. 3A and 3B are front and rear views, respectively, of user device 202-x. User device 202-x may include any of the following devices with self-locating or GPS capabilities: a mobile telephone; a cell phone; a personal communications system (PCS) terminal that may combine a cellular radiotelephone with data processing, facsimile, and/or data communications capabilities; a laptop; a personal digital assistant (PDA) that can include a telephone; a gaming device or console; a peripheral (e.g., wireless headphone); a digital camera; or another type of computational or communication device.

In this implementation, user device 202-x may take the form of a portable phone (e.g., a cell phone). As shown in FIGS. 3A and 3B, user device 202-x may include a speaker 302, a display 304, control buttons 306, a keypad 308, a microphone 310, sensors 312, a front camera 314, a rear camera 316, and a housing 318. Speaker 302 may provide audible information to a user of user device 202-x. Display 304 may provide visual information to the user, such as an image of a caller, video images received via rear camera 316 (e.g., road scenes), or pictures. In some implementations, display 304 may include a touch screen via which user device 202-x receives user input.

Control buttons 306 may permit the user to interact with user device 202-x to cause user device 202-x to perform one or more operations, such as place or receive a telephone call, record videos of a trip, etc. Keypad 308 may include a standard telephone keypad. Microphone 310 may receive audible information from the user and/or the surroundings. Sensors 312 may collect and provide, to user device 202-x, information (e.g., acoustic, infrared, etc.) that is used to aid the user in capturing images or in providing other types of information (e.g., a distance between a user and user device 202-x).

Front camera 314 and rear camera 316 may enable a user to view, capture and store images (e.g., pictures, video clips) of a subject in/at front/back of user device 202-x. Front camera 314 may be separate from rear camera 316 that is located on the back of user device 202-x. Housing 318 may provide a casing for components of user device 202-x and may protect the components from outside elements.

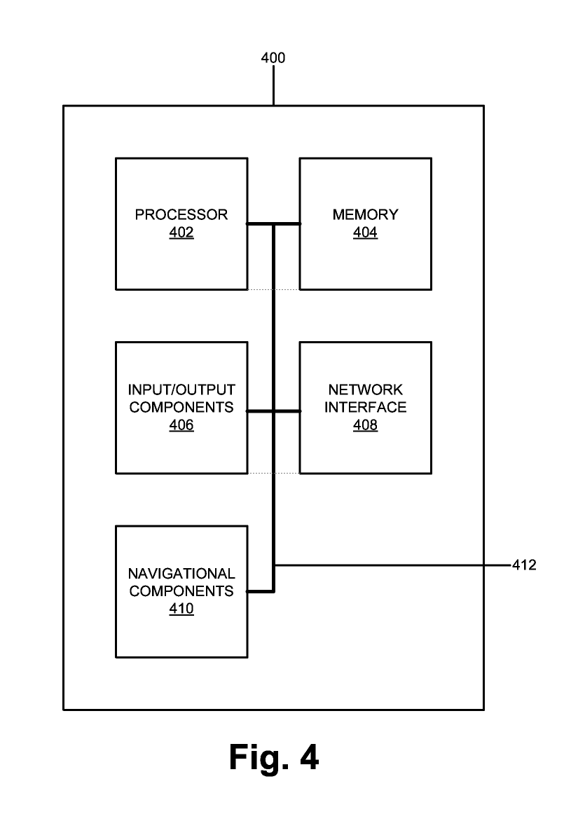

FIG. 4 is a block diagram of exemplary components of a network device 400, which may represent any of devices 202 or 206. As shown in FIG. 4, network device 400 may include a processor 402, a memory 404, input/output components 406, a network interface 408, navigational components 410, and a communication path 412. In different implementations, network device 400 may include additional, fewer, or different components than the ones illustrated in FIG. 4. For example, network device 400 may include additional network interfaces, such as interfaces for receiving and sending data packets.

Processor 402 may include a processor, a microprocessor, an Application Specific Integrated Circuit (ASIC), a Field Programmable Gate Array (FPGA), and/or other processing logic (e.g., audio/video processor) capable of processing information and/or controlling network device 400. Memory 404 may include static memory, such as read only memory (ROM), and/or dynamic memory, such as random access memory (RAM), or onboard cache, for storing data and machine-readable instructions. Memory 404 may also include storage devices, such as a floppy disk, CD ROM, CD read/write (R/W) disc, and/or flash memory, as well as other types of storage devices.

Input/output components 406 may include a display screen (e.g., display 304), a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to network device 400.

Network interface 408 may include a transceiver that enables network device 400 to communicate with other devices and/or systems. For example, network interface 408 may communicate via a network, such as the Internet, a terrestrial wireless network (e.g., a WLAN), a cellular network, a satellite-based network, a wireless personal area network (WPAN), etc. Additionally or alternatively, network interface 408 may include a modem, an Ethernet interface to a LAN, and/or an interface/connection for connecting network device 400 to other devices (e.g., a Bluetooth interface).

Navigational components 410 may provide position, velocity, acceleration, deceleration (e.g., retardation), and/or orientation information (e.g., north, south, east, west, etc.) to a user or other components of user device 202-x. Examples of navigational components include GPS receivers, a miniature or micro accelerometer and/or gyroscope, etc. Communication path 412 may provide an interface through which components of network device 400 can communicate with one another.

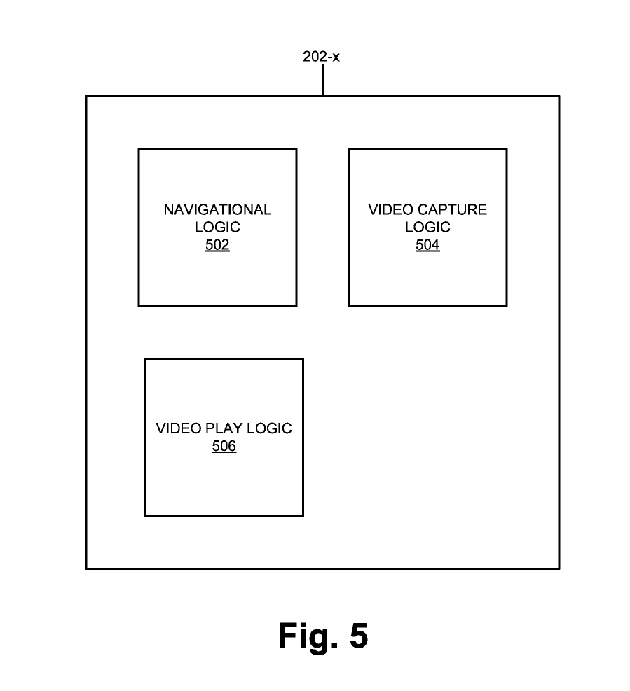

FIG. 5 is a block diagram of exemplary functional components of user device 202-x. As shown, user device 202-x may include navigational logic 502, video capture logic 504, and video display logic 506. Depending on the implementation, user device 202-x may include additional, fewer, or different functional components than those illustrated in FIG. 5. For example, in one implementation, user device 202-x may include an operating system, document application, game application, etc. In a different implementation, video capture logic 504 and video play logic 506 may be integrated as a single functional component.

Navigational logic 502 may obtain location/directional information, from, for example, navigational components 410 (e.g., a GPS receiver, a gyroscope, etc.), and provide the information to a user or other components, such as video capture logic 506. In some implementations, navigational logic 502 may include a user interface via which navigational logic 502 receives input that identifies, for example, a starting location and an end location of a trip.

Video capture logic 504 may create a video clip of images that are provided by, for example, front camera 314, rear camera 316, etc. In creating the video clip, video capture logic 504 may associate the video clip to a trip (e.g., a starting point and an endpoint of a route on a map). Further, video capture logic 504 may tag or associate each frame of the video clip with parameters, such as physical coordinates of user device 202-x, time during the trip, and/or relative position of user device 202-x from a previous position or on a map. The tags may be used by an application to manage the video clip (e.g., organize the video clip in a database, merge the video clip into another video clip that spans a longer trip, subdivide the video clip into smaller clips, each corresponding to portions of the trip, etc.) or to retrieve the video clip from a database.

When capturing video, video capture logic 504 may adapt the rate at which images are being captured. For example, assume that video capture logic 504 stores each frame in Video Graphics Array (VGA) format; each frame includes 480×320 pixels; 2 bytes represent each pixel; and video capture logic 504 captures 1 frame each time user device 202-x travels 27.77 meters. If user device 202-x is traveling at 100 kilometers per hour (km/h), video capture logic 504 may capture approximately 1 frame per second, or use 480×320×2×60/1,000,000 Megabytes per minute (Mb/m)=18.432 Mb/m. In another example, if user device 202-x is traveling at 50 km/h and is obtaining 1 frame per second, video capture logic 504 may capture approximately 1 frame every 13.88 meters, or use 480×320×2×30/1,000,000 Mb/m=8.22 Mb/m.

Accordingly, video capture logic 504 may change the rate of image capture to limit the amount of captured video. For example, on a highway, where the speed of user device 202-x is high and scenes are relatively static, a distance between each of sample images may be large. In contrast, scenes in a city or a municipal area may vary greatly between short distances, and therefore, may require images to be captured at a greater rate. In one implementation, a rate of change in the scenes may be obtained by comparing an image to a subsequent image of the video (e.g., by obtaining a difference between two consecutive images of the video).

Depending on the configuration/implementation, video capture logic 504 may use one or more factors (e.g., speed of travel, road conditions (e.g., wet), geographical location, weather, how much images change when user device 202-x moves a particular distance, lighting conditions (e.g., daytime, nighttime, etc.), time of the day, month of the year, speed limit, zoning (as shown on a map), etc.) in determining the rate at which video capture logic 504 obtains images. Once images are captured, video capture logic 504 may store the images in a local memory (e.g., memory 404) or transmit the captured video to a remote device (e.g., server device 206) to be stored.

In some implementations, video capture logic 504 may allow the user to “tag” a place of interest in the video during the trip by via input/output components 406 (e.g., keys on keypad 308, control buttons 306, touch screen, etc.). The tag may include text, image, sound, speech, etc.

Video play logic 506 may play live video or stored videos (e.g., travel videos). The travel videos may be obtained from a local storage (e.g., memory 404) or from a remote device. In one implementation, video play logic 506 may provide a graphical user interface via which the user may view a video clip that is associated with a specific portion of a trip.

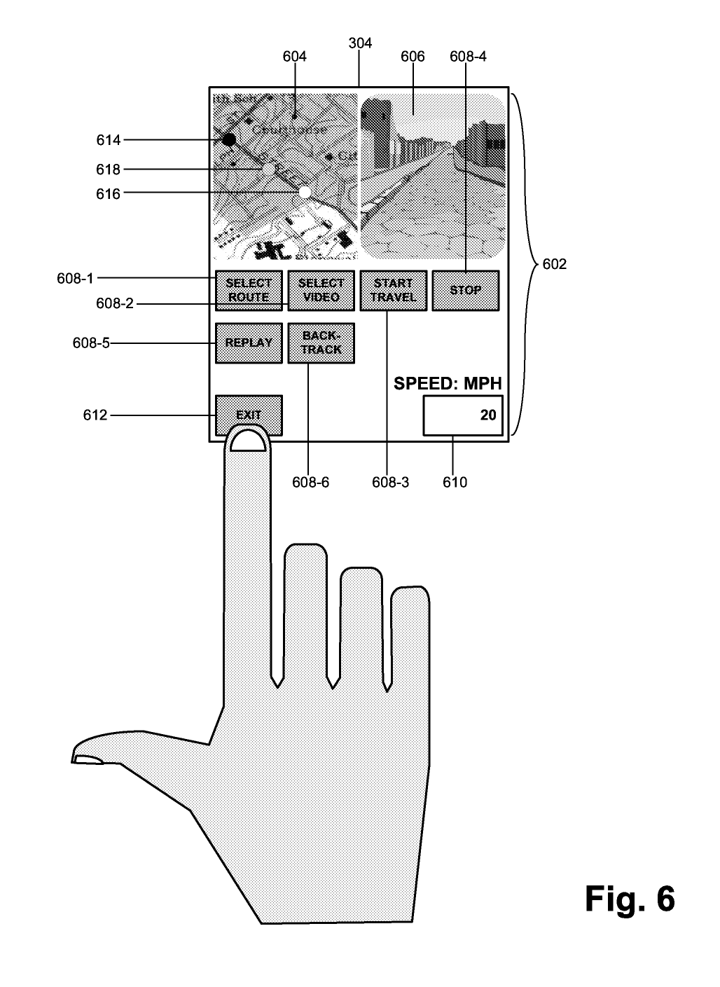

FIG. 6 is a diagram of an exemplary graphical user interface (GUI) window 602 of video play logic 506. As shown, GUI window 602 may include a map pane 604, video pane 606, select route button 608-1, select video button 608-2, start travel button 608-3, stop button 608-4, replay button 608-5, backtrack button 608-6, speed input box 610, and exit button 612. Depending on the implementation, GUI window 602 may include additional, fewer, or different GUI components than those illustrated in FIG. 6. For example, in one implementation, GUI window 602 may include components for receiving user input for selecting a source from which travel videos may be downloaded. In another implementation, GUI window 602 may be implemented as a web interface, and may include components that are typically associated with web pages.

Map pane 604 may illustrate a map of an area that includes the route of a trip (i.e., a travel path). Video pane 606 may display a travel video, which may be obtained from a local storage or downloaded from a remote device.

Select route button 608-1 may pop open one or more boxes into which a user may input a route (e.g., a starting location and an end location).

Select video button 608-2 may allow a user to select, for the selected path, one of multiple video clips that may be available. The user may be provided with a list of best films, as determined by votes from other users, from which the user may make a selection. The list of videos may include videos of the same route, but taken while traveling in two different directions.

Start travel button 608-3 and stop button 608-4 may start and stop playing the travel video in video pane 606. Replay button 608-5 may replay the travel video, and backtrack button 608-6 may play the travel video in reverse.

Speed input box 610 may receive a speed at which video pane 606 may display the travel video. A user may input positive velocity or slower speed to adjust the rate at which the video is displayed. In some implementations, the user may input negative speed to view the video in reverse. Activating exit button 612 may allow a user to exit from GUI window 602.

In some implementations, map pane 604 may allow a user to select routes that are shown in map pane 604 via a touch screen provided on user device 202-x. For example, in one implementation, a user may indicate a starting point 614 and end point 616 of a trip by touching the surface of display 304. Map pane 604 may also show a location 618, on the map, that corresponds to the frame being displayed on video pane 608. In one implementation, the user may control frames that are displayed on video pane 606 by dragging corresponding location 618 on the route on map pane 604. Video play logic 506 may use location and/or time information with which frames of the selected video clip have been tagged to display corresponding images.

Although not illustrated in FIG. 6, a user may be provided with GUI components for grading a particular video. Assuming that the video is stored in a database at server device 206, the grade may be stored along with the video and other grades provided by other users. When the user is presented with different videos of a path, the user may select a particular video based on the grades.

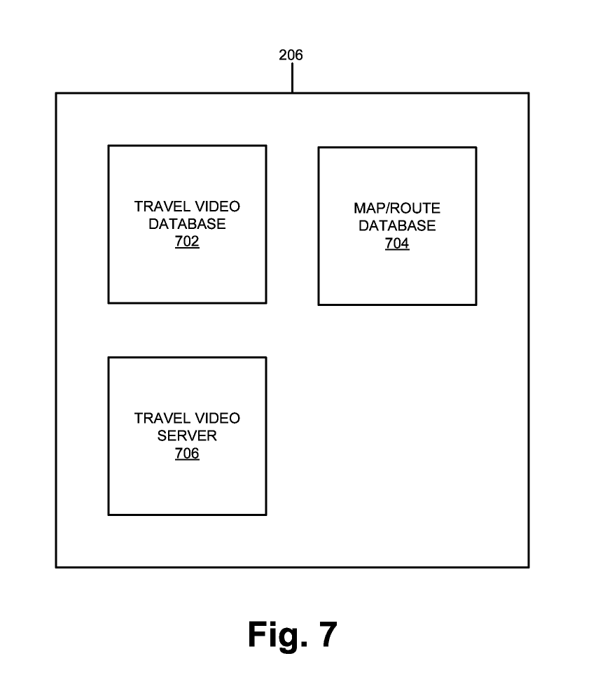

FIG. 7 is a block diagram of exemplary functional components of server device 206. As shown, server device 206 may include travel video database 702, map/route database 704, and travel video server 706. Depending on the implementation, server device 206 may include additional, fewer, or different components than those illustrated in FIG. 7. Further, in some implementations, one or more of the components may be distributed over multiple devices.

Travel video database 702 may include travel videos that are received from different user devices 202. In one implementation, travel video database 702 may organize received videos in different classes/types (e.g., a rear view, side view, front view, travel video unrelated to road views, winter view, summer view, etc.).

In another implementation, travel video database 702 may store a travel video received from user device 202-x in portions that correspond to segment of a routes. When user device 202-x requests a travel video, server device 206 may splice different video portions in travel video database 702 to compose the requested travel video and send the composed travel video to user device 202-x. Because travel video database 702 may include travel videos from many different user devices 202, the user of device 202-1, for example, may view a travel video that is a composite of video images created by other user devices, such as user devices 202-2 and 202-3.

In some implementations, travel video database 702 may include a large number of videos captured for the same route. In order to help users in selecting the best video, travel video database 702 may also include, along with each video, grades that are provided by the users for the video. The grades may be based on how much information the video contains (e.g., quality of the video, other subjective criteria, etc.). In one implementation, an application in user device 202-x or server device 206 may automatically grade the videos by picture quality, age, amount information added, light conditions, etc.

Map route database 704 may include maps and/or route information. The route information may be used to determine a route or route segments (e.g., components of a route) between a starting point and an end point of a trip.

Travel video server 706 may receive a request from user device 202-x for one or more travel videos that correspond to a trip. Each request may provide at least a starting point and an endpoint of a route. Given the request, travel video server 706 may determine a route (e.g., a set of route segments that form the route) based on information from map/route database 704, and retrieve video clips that correspond to each of the segments of the route. Travel video server 706 may be implemented via a web server, application server, and/or another type of server application.

### EXEMPLARY PROCESSES

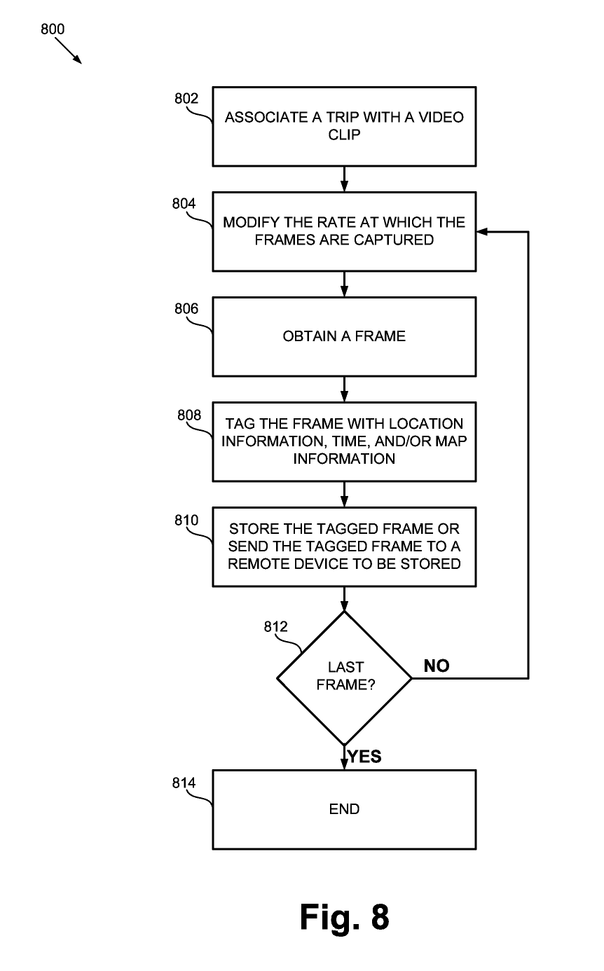

FIG. 8 is a flow diagram of an exemplary process 800 that is associated with user device 202-x. Assume that a video clip is being created or is about to be created. Process 800 may begin by associating a trip with the video clip (block 802). In associating the video clip with the trip, user device 202-x may receive from a user, via a GUI interface of an application (e.g., a GPS application, navigational logic 502, etc.), information that identifies the trip (e.g., an end location of the trip, a starting point of the trip, etc.). In some implementations, user device 202-x may use the current location of user device 202-x as the starting location, as provided by, for example, navigational logic 502 or by the user.

Video capture logic 504 may set or modify the rate at which frames of the video clip are captured (block 804). As described above, in one implementation, video capture logic 504 may change the rate which images are captured based on the speed of travel, locations, time of travel, etc.

Video capture logic 504 may capture a frame of video (block 806), In one implementation, video capture logic 504 may begin to capture frames of the video when the user begins the trip, or, alternatively, when the user provides an input signaling video capture logic 504 to begin capturing the video.

Video capture logic 504 may tag the frame with location information, time, and/or map information (block 808). The location information may include, for example, longitude, latitude, altitude, etc. The time information may include a number of minutes, seconds, or hours after the start of the trip or the start of video capture, an absolute time in GMT, etc. The map information may include coordinates on a map, an index designating the map to which the coordinates reference, etc.

Video capture logic 504 may store the tagged frame on user device 202-x or send the tagged frame to a remote device (e.g., server device 206) (block 810). The tagged frame may be stored, either locally or remotely, as part of a travel video.

At block 812, video capture logic 504 may determine whether the last frame of the video clip has been processed (block 812). In one implementation, video capture logic 504 may determine whether the last frame has been processed by determining whether the end of the trip has been reached (e.g., compare the current location of user device 202-x to the end location of the trip), or, alternatively, based on user input.

If the end of the trip has not been reached (block 812—NO), process 800 may return to block 804, to continue to perform blocks 804-812. If the end of the trip has been reached (block 812), process 800 may terminate. In terminating, process 800 may perform clean-up tasks, such as finishing the creation of the video clip, notifying a remote device that the trip has ended if the remote device has been involved in creating/storing the video clip, notifying the user of user device 202-x that the trip is no longer being recorded, etc. In some implementations, however, process 800 may not end at block 812, but may continue indefinitely (e.g., user device 202-x may continuously capture video).

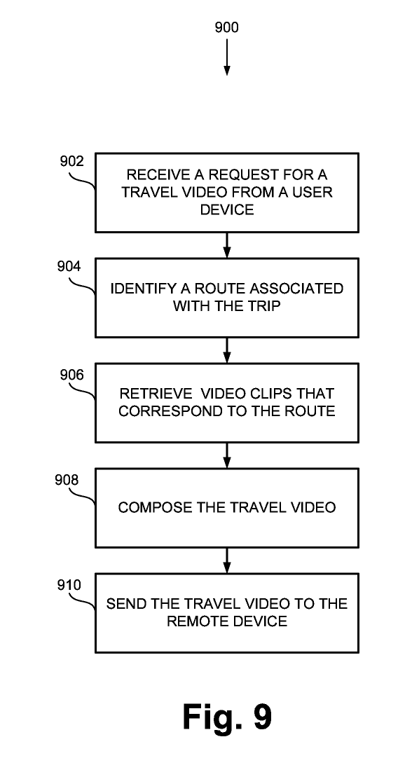

FIG. 9 is a flow diagram of an exemplary process that is associated with server device 205. Assume that the user at user device 202-x wants to view a specific travel video.

Travel video server 706 may receive a request for a travel video from user device 202-x (block 902). The request may include information that identifies a trip (e.g., a starting point and an end point of a trip), the type of travel video (e.g., a view of roads from the front of a driven vehicle, a side view of roads (e.g., north side, south side, passenger window view, etc.), views of passengers, a month on which the video is captured, etc.), weather conditions, a user id of a driver/passenger, a user account number, a phone number, etc.

Travel video server 706 may identify one or more routes of the trip (block 904). In one implementation, travel video server 706 may identify a starting point and an end point of the trip based on the request received from user device 202-x, and, based on the starting/end points, obtain a list of possible routes from map/route database 704. Each of the routes may correspond to a different path via which the end point may be reached from the starting point.

Further, travel video server 706 may select a single route from the list of routes. For example, in one implementation, travel video server 706 may send a message to user device 202-x, requesting user device 202-x to select one route among those in the list. In another implementation, travel video server 706 may select a route that provides the shortest distance between the starting location and the end location. In yet another implementation, travel video server 706 may select a path that may be traveled fastest (e.g., based on traffic) from the starting location to the end location.

Travel video server 706 may retrieve video clips that correspond to the selected route from travel video database 702 (block 906). In one implementation, the route selected at block 904 may be composed of smaller, sub-paths. To retrieve the video clips, travel video server 706 may retrieve, for each of the sub-paths, a corresponding video clip from travel video database 702. Each of the video clips should correspond to the criteria of block 902. In some implementations, travel video server 706 may retrieve more than one video clip for a sub-path and interleave the video clips to obtain one clip for the sub-path. Further, if a video clip is unavailable for a specific sub-path, travel video server 706 may obtain a “blank” video clip (e.g., an advertisement, a blank video clip, etc.) for the sub-path.

Travel video server 706 may assemble the retrieved video clips to compose the travel video requested by user device 202-x (block 908). Subsequently, travel video server 706 may send the composed travel video to user device 202-x (block 910) over network 204.

When user device 202-x receives the travel video, user device 202-x may display the travel video to the user. By viewing the travel video, the user may identify or recall interesting events or pieces of information.

### Example

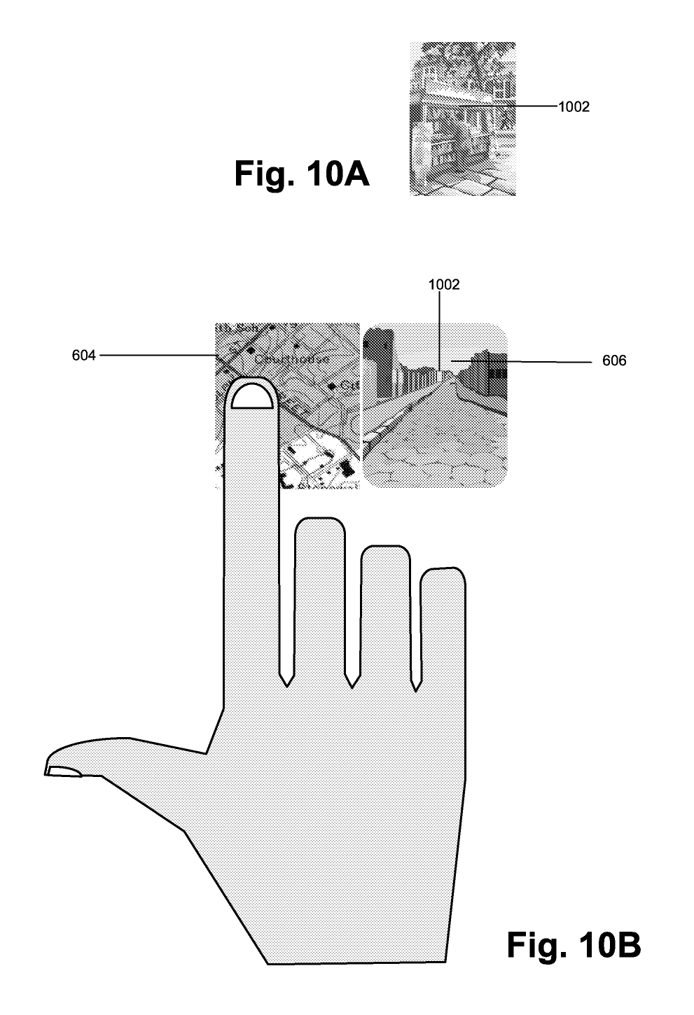

FIGS. 10A and 10B illustrate an example associated with the processes of FIGS. 8 and 9. Assume that Kristian is ready to start a road trip near Lexington. Kristian places his mobile phone on a stand above the dashboard of his car, allowing a rear camera on the back of the mobile phone to captures images at the front of his car.

Before starting his trip, Kristian launches video capture logic 504 (e.g., via an application) and inputs a destination into a GPS application installed on his mobile phone. The GPS application conveys the destination information and information on the starting location of the trip (e.g., the current location of the mobile device) to the video capture logic 504. Video capture logic 504 associates the trip with a video clip that video capture logic 504 is in the process of creating.

Kristian begins to drive, video capture logic 504 records scenes in front of Kristian's car. Video capture logic 504 adjusts the rate at which frames of the video is being acquired.

At one point during the trip, Kristian stops by a roadside ice cream kiosk, and purchases an ice cream cone. FIG. 10A illustrates kiosk 1002. Eventually, Kristian concludes his trip, and video capture logic 504 finishes creating the video clip associated with the trip.

Two weeks later, Kristian shows the video clip to a friend, Liz, who is planning a trip near Lexington. Kristian pulls out his mobile phone, and launches video play logic 504. Assume that video play logic displays a GUI window 602. FIG. 10B shows a map pane 604 and video pane 606 of GUI window 602.

Kristian tells Liz, “You must visit this wonderful ice cream kiosk on a side of a road bear Lexington!” To show Liz where kiosk 1002 is located, Kristian places a finger on map pane 604 and drags point 618 (FIG. 6) along the route that Kristian traveled. As Kristian drags point 618, video pane 606 “fast forwards” through different frames of the travel video. When Kristian sees kiosk 1002 in one of the frames, Kristian stops dragging his finger on map pane 604. Kristian shows Liz where kiosk 1002 may be found and what kiosk 1002 looks like.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in one implementation, user device 202-x may include a video editor in user device 202-x. The video editor may download videos from a remote device (e.g., server device 206) in a similar manner that video play logic 506 obtains a video from server device 206. Further, the video editor may allow a user, a company, and/or other types of organizations to add names, offers of products/services, web page addresses, logos, trademarks, etc. directly in the videos, or splice in another video that includes a commercial or an advertisement.

For example, an owner of ice cream kiosk 1002 can add the name of kiosk 1002, prices, web page addresses in videos with scenes of areas that are close to kiosk 1002. When a user plays one of the edited videos during a trip near kiosk 1002, the added information may pop up when the user is close to or before the user arrives at kiosk 1002 (e.g., so that the user may prepare to stop and purchase the advertised product)

In another implementation, when a user edits a video for the purpose of advertising, the user may be charged a fee, for example, by the provider of the video database or by a user that created the video. In some embodiments, the creator of the video or the provider of the database may be given an authority to restrict what types of commercials or advertisements may be added on or spliced with their videos.

In the above, while series of blocks have been described with regard to the exemplary processes illustrated in FIGS. 8 and 9, the order of the blocks may be modified in other implementations. In addition, non-dependent blocks may represent acts that can be performed in parallel to other blocks. Further, depending on the implementation of functional components, some of the blocks may be omitted from one or more processes.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A device comprising:
a processor configured to:
associate a trip with a first video clip,
modify a rate at which images for frames of the first video clip are captured,
create the frames of the first video clip based on the images,
tag each of the frames with location information, the location information designating a point on a path of the trip, and
store the first video clip.

2. The device of claim 1, wherein the processor is configured to: modify the rate based on at least one of road conditions or weather conditions.

3. The device of claim 1, wherein the processor is configured to: modify the rate based on speed at which the device is moving.

4. The device of claim 1, wherein the processor is configured to: modify the rate based on at least one of time of day or month of year.

5. The device of claim 1, comprising a mobile phone.

6. The device of claim 1, further comprising:
a rear camera for capturing the images.

7. The device of claim 1, further comprising:
a network interface to transmit the first video clip to a remote device at which the first video clip is to be stored.

8. The device of claim 1, wherein the location information includes at least one of:
information identifying a geographical location of the device;
information identifying a time at which an image corresponding to the frame is captured; or
coordinates on a map associated with the trip.

9. The device of claim 5, further comprising:
navigational components,
wherein the processor is further configured to:
obtain, from the navigational components, the information identifying the geographical location.

10. The device of claim 1, further comprising:
a display, wherein the processor is further configured to:
receive information to identify and retrieve a second video clip from a remote device; and
display the second video clip on the display.

11. The device of claim 10, wherein the information to identify the second video clip includes information for identifying the trip.

12. The device of claim 1, further comprising:
a display to:
show an interactive map, and
play a portion of a video clip based on user input received via the interactive map.

13. The device of claim 9, wherein the processor is further configured to:
receive user input identifying at least one of:
a location on a route of a trip associated with the second video clip,
a time during a trip associated with the second video clip, or
a position on a map that includes a route of a trip associated with the second video clip; and
play a portion of the second video clip, the portion corresponding to the user input.

14. The device of claim 1, wherein the processor is further configured to:
associate a start location and an end location of the trip with the first video clip.

15. A method comprising:
receiving a request for a travel video from a user device, the travel video associated with a trip;
identifying a route of the trip;
retrieving video clips that correspond to the route;
assembling the travel video by combining the video clips; and
sending the travel video to the user device.

16. The method of claim 15, wherein identifying the route of the trip includes:
obtaining from the request, information identifying a start location and an end location of the trip;
retrieving a list of routes based on the information; and
selecting the route from the list of routes.

17. The method of claim 16, wherein assembling the travel video includes:
interleaving at least two of the video clips; or
concatenating the video clips.

18. The method of claim 15, wherein retrieving the video clips includes:
retrieving the video clips from a plurality of user devices.

19. A method comprising:
associating a travel video with information that identifies a trip;
modifying a rate at which images of the travel video are captured;
creating frames of the travel video from the images;
tagging each of the frames with location information, the location information designating a point on a path of the trip; and
storing the travel video.

20. The method of claim 19, further comprising:
displaying an interactive map; and
displaying a video clip based on user input received via the interactive map.
